(19) United States
(12) Patent Application Publication
(10) Pub. No.: US 2023/0114590 A1
(43) Pub. Date: Apr. 13, 2023

(54) ORAL HEALTH AND IMMUNE MODULATORY DIETARY SUPPLEMENTS

(71) Applicant: INTEQ, LLC, OVERLAND PARK, KS (US)

(72) Inventor: GARY PUSILLO, MARSHALLTOWN, IA (US)

(21) Appl. No.: 18/045,977

(22) Filed: Oct. 12, 2022

Related U.S. Application Data
(60) Provisional application No. 63/255,096, filed on Oct. 13, 2021.

(51) Int. Cl. A23K 10/16; A23K 20/147; A23K 20/28

(52) U.S. Cl. CPC A23K 10/16; A23K 20/147; A23K 20/28

(57) ABSTRACT

Novel products formulated for use as nutritional supplements are designed to enhance oral health and immune function in mammals. An exemplary composition can be customized by adding nutritional or therapeutic ingredients according to a health condition or medical requirement. Oral formulations are described which can be used as dietary supplements on a daily basis to effectively prevent plaque formation in the oral cavity in addition to providing immune protection mediated by enhancing saliva secretions.

### FIELD OF THE INVENTION

The present invention relates to compositions formulated for maintaining oral health and enhancing immune resistance to inflammatory disorders. The compositions support a healthy oral cavity environment and are effective in preventing plaque formation.

### BACKGROUND OF THE INVENTION

Dietary inputs to provide adequate nourishment in food are well recognized. Many diets are supplemented to varying degrees with vitamins and minerals which are important for metabolic functioning. Additional ingredients may include antioxidants or various enzyme supplements.

Oral health is important because health and basic mechanical functions in the mouth involve a multitude of interactions related to digestive functioning, control of inflammation and balancing of a variety of microbial species found in all mammalian oral cavities. Multiple bacterial types present in the mouth can lead to periodontal disease. Dry mouth lacking sufficient saliva may interfere with digestive flora and other functions that require the presence of saliva.

Oral diseases can affect numerous aspects of basic health and function, including ability to eat and drink, swallow, maintain proper nutrition, physical activity. A number of medical conditions have important oral symptoms, manifestations or complications. The lips, tongue, gingivae, oral mucosa, and salivary glands can all signal clinical disease elsewhere in the body. Long considered to be localized infections only, periodontal diseases are now being investigated as potential risk factors for the development of cardiovascular disease and pulmonary disorders. Oral diseases can be detrimental to the overall health and well-being. Fortunately, many of the diseases and disorders of the mouth can be prevented, or problems reduced, by vigilant hygiene practices.

Numerous conditions are associated with compromised nutritional and oral health status. The list is long and includes anorexia, cardiovascular disease, craniofacial anomalies, developmental disorders, diabetes, disorders of taste and smell, early neonatal infections, lesions and injuries, end-stage renal disease, erosion of teeth, excessive or overuse of medications such as antibiotics, fad or nutrition quackery, gastrointestinal disorders, hypertension, heavy metal consumption, immunocompromising conditions such as cancer, parasitic infection, neonatal periodontitis, oral sarcoma, mycotoxin exposure, musculoskeletal disorders, neoplastic disease, osteoporosis, polypharmacy, poor dentition/edentulism, protein malnutrition, quadriplegia, radiation therapy, salivary dysfunction, specific disease states such as oral cavity ulcers, xerostomia and zinc deficiency.

A particularly common infectious disease in humans as well as in herd and companion animals is periodontal disease caused by inflammation of the tissues around and supporting the tooth. Tooth support structures include the gingiva, the cementum and periodontal ligament and the alveolar bone. Periodontitis indicates some degree of periodontal attachment tissue loss. The plaque bacteria found in the thin sticky film that builds up on the teeth are the major cause of periodontitis in humans and animals.

Plaque is a sticky film that forms on teeth when oral bacteria mix with foods that can provide nutrients for bacterial growth, usually sugars and starches. If plaque is not removed it hardens into tartar which can cause bone disintegration and soft tissue inflammation. Humans are particularly to dental plaque formation because sugar is often a significant part of the diet. Herd and companion animals are also susceptible to dental plaque due to feed and diet composition.

Prevention and treatments for plaque typically include scrubbing or scraping the tooth surface. Buildup can be prevented by daily brushing, flossing and rinsing the oral cavity. Popular mouthwashes and toothpastes are available which can be used to prevent or alleviate plaque formation.

Few products are available for addressing total oral health care. Pastes can be used to provide visibly clean teeth while other available products are formulated specifically to freshen breath. Such products are typically for independent use as needed but do not address underlying health issues that may originate in the oral cavity.

### SUMMARY OF THE INVENTION

The oral health products of the present invention are designed for daily use in maintaining oral health and supporting innate disease resistance mediated by saliva. The basic composition includes a zeolite, bacterial enzymes and a unique peptide mixture that supports saliva functions and has a direct influence on the essential components produced or found in saliva. This product, can be formulated with additional ingredients to enhance selected physiological parameters. Additional components that support certain organ functions or improve digestive function include probiotics and essential fatty acids can provide further benefits. Beneficial minerals such as zinc and iron, and ingredients that strengthen or support the immune system can also be included.

Saliva serves a multifunctional role by directly or indirectly protecting against bacterial, viral and fungal infections, supporting the digestion system, and promoting mineralization, lubrication and viscoelasticity, tissue coating and buffering. In one aspect of the present invention, the product serves as an overseer food supplement to enhance the important multiple functions of saliva because it provides support and guardian protection for saliva and its important functions in the oral cavity.

Saliva is the major, non-structural component of the oral cavity. Normal saliva production is related closely to chewing and intake of foods. The daily production of saliva can range dramatically depending on age, diet, water intake, environmental conditions, oral health, and activity level. Constant bathing of the gastrointestinal track with saliva is very important in the prevention and reduction of ulcers and certain types of GI track abnormalities. Excessive salivation can result from salivation-inducing plants, chemicals, irritants, injury, inflammation, swallowing difficulties, disease, certain types of GI abnormalities, tongue abnormalities, sharp points on teeth, and toys.

The microbiome of the oral cavity and especially the commensal facultative anaerobes on the tongue have a direct effect on the saliva and plasma level of nitrates and nitrites. The salivary glands and oral bacteria play an essential role in the conversion process from nitrate (NO₃—) and nitrite (NO₂—) to nitric oxide (NO) in the human body. The studies reported herein have shown that the cat oral microbiome also affects the same conversion process. Salivary flow is a continuous process that is upregulated by a reflex mostly stimulated by taste and chewing. Some of the cats' salivary glands are more responsive to changes in the diet and contribute more to the salivary flow that is an individualized level when not upregulated by taste and chewing.

Total salivary nitrates and nitrites are higher in humans with periodontal disease. The increase in nitrate secretion and a subsequent increase in salivary nitrite may contribute to the overall protective effect against those infections' conditions. It is known that salivary glands may respond to periodontitis by enhancing the protective potential of saliva. It is likely that the increment of salivary nitrate/nitrite concentration in subjects with periodontal disease is due to an increase in nitrate secretion as a response of salivary glands to the inflammatory process. Because nitrate is described as the basis of a non-immune system mediated defense mechanism against gastrointestinal and oral pathogens in animals and humans, its increase in cases of periodontal disease is associated with the host defense reaction.

The salivary glands and oral bacteria play an important role in maintaining NO homeostasis in the human body. Dysfunction of salivary glands and oral bacteria may lead to a decrease of NO generation from the enterosalivary pathway of NO₃—, —NO₂—, —NO. The current invention provides a reliable way to combat oral health challengers and help maintain homeostasis in the individual's oral microbiome. As the normal oral microbiome is maintained, the gastrointestinal microbiome is also maintained in the desired state to achieve genetic expression of individualized health and quality of life.

The novel active peptide, 1111, product is key to a more comprehensive response to daily salivary needs for NO. Several factors contribute to not only the overall oral and nasopharyngeal response, but also to the benefits of maintaining proper nitric oxide levels. Nitric oxide (NO) is an important cellular signaling molecule involved in many physiologic and pathologic processes in human beings. Recently, the level of NO has been shown to enhance the performance of horses. Horses gain a competitive advantage simply by having the oral microbiome that is essential in the conversion process from nitrate and nitrite to nitric oxide. Beneficial health effects for dogs and cats have also been observed.

The present invention enhances oral cavity and body organ health when used on a daily basis vs. oral antimicrobial rinses, Chlorhexidine application, and microbiome destructive chemicals used by veterinarians which may have negative effects on oral health.

Oral health care should address more than clean teeth or bad breath. The oral cavity contains many tissues and structures that interact to create what ultimately is optimized oral health. Optimal care via food supplementation can be provided on different levels of preventive care depending on the species, age and living conditions. In assessing the needs for a dog or cat as well as humans; for example, the breed, diet, environment, behavior, microbiome and life history are ideally considered in order to determine what, if any, additions can be beneficially included with the disclosed oral health “premix”.

Many diseases present or manifest symptomatically in the oral cavity. Oral disease can be detrimental to overall health and well-being. A number of medical conditions have distinct oral symptoms, manifestations or complications. The lips, tongue, gingivae, oral mucosa and salivary glands can all signal clinical disease elsewhere in the body. Long considered to be localized infections only, periodontal diseases are now being investigated as potential risk factors for the development of cardiovascular disease and pulmonary disorders.

The oral premix disclosed herein can be formulated as a basic oral health support product. While some additional ingredients are particularly beneficial for dogs and cats, other or different additives can be more specifically tailored for herd and companion animals and adjusted for age and life environment by altering ratios and/or adding a specific nutrient or therapeutic ingredient. The oral products are useful for human use, not only for nutritional benefit but significantly as an effective barrier to plaque formation on the teeth.

### DETAILED DESCRIPTION OF THE INVENTION

Important ingredients of the novel compositions are the combination of live, naturally occurring microorganisms, zeolites, and a mixture of unique fermented milk peptides. This basic mixture can be supplemented with vitamins, fat, minerals or other health ingredients to customize the described compositions for oral health requirements, whether in humans or other mammals including herd and companion animals.

The invention provides specially formulated oral health supplements that contribute to maintaining a healthy oral cavity and influence salivary immune functions. Dietary inputs can help in activating immune responses to exposure to pathogens, toxins and environmental insults that attack the body initially by entry through the oral or nasal cavity. Depending on the type and nutritional requirements in any mammal, several basic dietary supplements can be prepared to support a normal healthy nasopharyngeal environment. Selected additional components can be added to the basic compositions to further modify or enhance other functions of saliva.

The ingredients of the disclosed oral health products are selected for compatibility and enhancement of saliva functions. The combination of ingredients improves oral cavity physical appearance of teeth and gingiva in addition to supporting several metabolic actions related to systemic immunity and internal organ functioning naturally promoted or provided by oral cavity saliva. Important components of the disclosed basic oral cavity premixes are peptide blend 1111, zeolites and enzyme mixtures which in combination are major contributors to oral cavity health and immunity support.

Peptide blend 1111 of the premix is a protein mixture consisting of 90-100 percent β-lactoglobulin, α-lactalbumin, albumin and immunoglobulins isolated from fermented colostrum whey.

Zeolites are minerals typically composed of aluminum and silicon and may comprise up to 50% of an oral premix. When the premix is used to supplement daily feeding, zeolites have a physical cleaning and scrubbing effect on teeth and can also absorb heavy metals such as lead, cadmium, copper and zinc.

Natural zeolites have three-dimensional crystal structures, irregular shells and high surface area. Although crystalline alumino-silicates are used extensively in dentifrice compositions, natural zeolites can also act as ion exchange matrices. The zeolite lattice has a net negative charge within the open structure pore space which holds absorbed cations such as calcium, magnesium, potassium, and sodium. Cation exchange capacity (CEC) varies between different natural and synthetic zeolites.

Clinoptilolite natural zeolite, which is a hydrated sodium calcium aluminosilicate, has several attributes that contribute to a robust oral health product. Compared to other hydrated aluminosilicates, the ratio of silica to aluminum is 5 to 1 in clinoptilolite compared to 1 to 1 in the aluminosilicates. Clinosilicates do not break down in a mildly acid environment, have a low water content and can differ in particle size. The disclosed oral health formulations which can include up to 50% zeolite are most effective with use of natural zeolites such as clinoptilolites, that have the stability, particle size and reactive surface to bind to and neutralize certain toxins in the oral cavity.

Active microbes and microbial products including yeast extracts can also be components of the disclosed oral premix. Several types of dried bacterial fermentation products comprise up to 30-45% by weight in most formulations with zeolites and peptide blend 1111 providing 50% or greater of the active ingredients. The bacteria may include bacillus, enterococcus and aspergillus bacteria as mixtures or individual species.

Probiotics, such as the active microbes comprising the oral premix, are used in food ingredients to promote a healthy flora in the intestine. Depending on the microbe, the effect may a metabolic effect, normalization of intestinal microbiota or a modulation of immune response. The inclusion of active microbes in the premix appears to enhance oral health, perhaps by altering the environment in the oral cavity to reduce effects of pathogens or changing the environment. This beneficial effect would be expected in the intestine but not in the oral cavity.

Active microbes included in the described oral products appear to support an immunomodulation effect. The bacteria may also influence the oral environment; rather than directly inhibiting oral pathogens may compete for an ecological niche or create unfavorable conditions for the pathogen to proliferate. Several metabolic effects have been attributed to probiotics, including increased disaccharide activity, production of antibacterial substances, competition for bacterial adhesion to enamel, stimulation of various immune defense mechanisms and particularly for saccharomyces, anti-secretory/protease effects against toxins and trophic effects on the mucosa.

To enhance the health effect of active microbes in a zeolite/peptide blend mixture, components such as vegetable fats, zinc, taurine, cranberry extract and Yucca Schidigera can be added. The additional ingredients each have recognized health benefits and are likely to further benefit oral health.

Other examples of modifying the compositions of the invention are products which combine any of a number of additional ingredients with the basic premix of zeolites, a mixed peptide blend isolated from fermented milk, lactic acid producing bacteria, and selected protease enzymes. Examples of optionally included ingredients are calcium, zinc, taurine, and ascorbic acid which provide additional health enhancements. In a particular example, a formulation designed to address specific oral cavity nutritional and health needs of dogs and cats is shown to be effective in preventing plaque formation.

Another oral health supplement premix includes small amounts of plant extracts from plant seeds such as anise, fenugreek and yucca which have anti-inflammatory effects. Added minerals and vitamins may include zinc, calcium, ascorbic acid. Taurine and astaxanthin can also be included in small amounts, each selected for recognized effects on body health and function. Astaxanthin and ascorbic acid have antioxidant properties. Taurine is an amino acid supportive of nerve growth.

The disclosed oral health premix is adaptable for preparation of customized products to meet unique nutritional and health needs at different stages of growth or life cycle. The formulations are also adaptable for human use as supplements or as a dentrifice.

An important use of the described products is for control and prevention of plaque buildup on teeth. This was demonstrated in dogs where Table 3 shows that daily use of the oral formulation was effective in preventing plaque formation compared to dogs not receiving daily supplementation.

Materials

Peptide blend 1111 is obtained from horse colostrum whey as a substantially pure mixture of β-lactoglobulin, α-lactalbumin, albumin, and immunoglobulins including IgG. The 1111 peptide blend can be prepared as a solution consisting of 90-100 weight % of the mixture components.

Lactobacillus acidophilus, Lactobacillus fermentum and Lactobacillus plantarum can be purchased from American Type Culture Collection (ATCC) or other similar culture collections throughout the world. Cultures are prepared culturing the bacteria for 24 hrs at 40-50° C. to between 9.0 and 7.0 log cfu/g and used directly as a liquid or dried.

Zeolites were purchased as Zar-Min Zeolyite. The product is a natural sodium aluminosilicate which is stable in the GI tract, has a high cation exchange and does not bind to minerals or vitamins.

1182 DFM & Enzyme Px (DFM/enzymes) is a dry mixture of direct fed microorganisms and enzymes. The microorganisms include strains of Bacillus amyloliquefaciens spores. The mixed enzymes include a multi-enzyme complex of xylanase, amylase and protease enzymes. 1182 can be purchased from Nature's Pharmacy (Jasper, Ga.) or other suppliers of DFM enzymes.

The present invention provides nutritional dietary supplements designed for daily use by humans or to supplement daily feeding for companion and herd animals. The basic composition of a novel peptide mixture, enzyme/bacterial mixture and a sodium aluminosilicate zeolite can be modified with additional ingredients to further enhance health benefits. Vitamins, minerals, essential fatty acids and various other health supplements are compatible with the disclosed supplements of the invention.

### EXAMPLES

The following examples are provided as illustrations of the invention and are in no way to be considered limiting.

### Example 1—Preparation of Peptide Blend 1111

Defatted equine colostrum is treated with rennet. Precipitated casein is removed by filtration. A lactose solution is added to the filtrate. The protein liquor is ultra-filtered and concentrated to provide a 90-100% peptide blend of β-lactoglobulin, α-lactalbumin, albumin and immunoglobulins in the proportions shown in Table 1.

TABLE 1

| Component | Proportion (%) | Isoelectric Point |
|---|---|---|
| β-lactoglobulin | 50-53 | 5.2-5.4 |
| α-lactalbumin | 22-25 | 4.5-5.1 |
| Albumin | 4-6 | 4.9-5.1 |
| Immunoglobulins | 16-20 | 5.8-8.3 |

### Example 2—Oral Health and Immunomodulatory Composition

An oral health product was formulated from zeolites, a DFM & Enzyme mix and peptide blend (1111) in the amounts shown in Table 2.

TABLE 2

| Ingredient | Weight % |
|---|---|
| Zar-Min zeolytes | 41.6 |
| 1111 peptide blend | 9.1 |
| DFM/enzymes | 43.5 |

### Example 3—Oral Health Formulation for Plaque Prevention and Gingival Health

Periodontitis is a severe gum disease that can cause inflammation and tooth loss. It is caused by bacteria that infect the tissue around teeth, resulting in gum inflammation. If not addressed, the bacteria can damage the bone that supports the teeth. Periodontitis can also increase risk of heart damage. In both humans and animals, treatment typically includes scaling, root planning, topical antibiotics and surgery.

In a test to evaluate the effect of 2.5 g daily supplementation with the oral health product of Example 4, 10 dogs between the ages of 3 and 6 were assigned to control and test groups after examination to make sure all had similar problems with oral health. The control group of 2 dogs consisted of 1 male and 1 female that were both neutered with each having a similar plaque score. The remaining 4 neutered males and 4 neutered females also had similar plaque scores.

During the 42-day test period the dogs were observed for swelling of gum tissue, bad breath, redness and edema of gums, ulcerations in the oral cavity, abscesses, white patches, gum surface bleeding and loose teeth. Plaque index measurements were used to compare plaque between the 8 test animals and 2 control dogs. At baseline and day 7, the plaque index scores of the test and control dogs were not statistically different as shown in Table 3.

The teeth of all dogs were professionally cleaned at day 7 and the plaque index comparison measured for all dogs at day 14 with data showing a statistical difference between control and test groups. At 14 days, feeding with the oral health formulation was discontinued. Plaque index measurements at days 28 and 42 continued to show significant differences between test and control groups when the animals were not receiving the oral health supplement. Plaque buildup was assessed on a scale of 1-5 with 5 being the most severe.

Table 3 shows a comparison of plaque Index comparison deviation between test and control groups.

TABLE 3

| | Base Line | 7 days | 14 days | 28 days | 42 days |
|---|---|---|---|---|---|
| Control | 2.60 | 0.80 | 1.22 | 1.42 | 1.7 |
| Test Group | 2.74 | 1.02 | 0.67 | 0.80 | 1.0 |

A gingival index comparison was also conducted on all 10 dogs initially and on days 7, 14, 28 and 42. As shown in Table 4, there was no statistically significant difference between the test and control groups at baseline, nor any significant difference after professional cleaning on day 7.

Gingival Index comparison was determined using conventional observation of gingival appearance deviation between test and control groups and assignment of number from 1-5 with 5 representing significant inflammation and gingivitis.

TABLE 4

| | Base Line | 7 days | 14 days | 28 days | 42 days |
|---|---|---|---|---|---|
| Control | 2.60 | 0.86 | 1.19 | 1.38 | 1.66 |
| Test Group | 2.74 | 0.98 | 0.70 | 0.81 | 1.07 |

### Example 4—Oral Health Formulation

Table 5 shows the weight % of ingredients for an oral health formulation suitable for daily use in companion and herd animals.

TABLE 5

| Ingredient | Weight percent |
|---|---|
| Vegetable fat | 2.340% |
| Natural Zeolites | 48.00% |
| dried Lactobacillus acidophilus fermentation product | 11.12% |
| dried Enterococcus faecium fermentation product | 9.82% |
| Anise oil | 1.780% |
| dried Aspergillus niger fermentation extract | 3.32% |
| dried Aspergillus oryzae fermentation extract | 2.76% |
| dried Bacillus subtilis fermentation extract | 2.26% |
| Cranberry powder | 2.000% |
| Calcium Carbonate | 1.00% |
| dried Lactobacillus casei fermentation product | 1.82% |
| Dried lactobacillus fermentum fermentation product | 1.72% |
| dried Lactobacillus plantarum fermentation product | 1.664% |
| Fenugreek seed extract | 0.800% |
| Yucca Schidigera Extract | 1.120% |
| Zinc Sulfate | 2.00% |
| Taurine | 0.40% |
| Astaxanthin | 0.50% |
| Ascorbic acid | 1.50% |
| Yeast fermentation soluble | 4.076% |

### Example 5—Oral Health Supplement

The oral health supplement of Example 2 was modified with additional ingredients to further benefit reduction of plaque formation and support of oral cavity health. An exemplary formulation is shown in Table 6.

TABLE 6

| Ingredient | Weight percent |
|---|---|
| 1182 DFM & Enzyme Px | 43.508 |
| 840 Zar-Min (Zeolyite) | 41.627 |
| 1111 Peptide blend | 9.091 |
| 809 Cranberry Ex Pwd | 2.182 |
| 677 Zinc Sulfate 35% | 1.909 |
| 007 ASCORBIC ACID | 0.909 |
| 200 Yucca extract | 0.545 |
| 750 Taurine 98.5% | 0.183 |
| 1155 Astaxanthin | 0.046 |
| Total | 100.000 |

### Example 6—Oral Health Supplement

Table 7 shows the composition of another example of an oral health supplement useful as a daily addition to feed for companion and herd animals. It comprises naturally occurring microorganisms, plant oils and extracts, zeolite and minor amounts of ascorbic acid, zinc, calcium and taurine in addition to zeolites and active peptide blend 1111.

TABLE 7

| Ingredient | Weight percent |
|---|---|
| Anise oil | 1.78 |
| Astaxanthin | 0.50 |
| B. subtilis | 2.26 |
| Calcium carbonate | 1.00 |
| Cranberry fruit powder | 2.00 |
| E. faecium | 9.82 |
| Fenugreek seed extract | 0.80 |
| L. acidophilus | 11.12 |
| Fermentum | 1.72 |
| Pantarum | 1.66 |
| Zeolite | 48.0 |
| Taurine | 0.40 |
| Coconut oil | 2.34 |
| Yeast fermentation solubles | 4.07 |
| Yucca root extract | 1.12 |
| Zinc sulfate | 2.00 |
| Ascorbic acid | 1.50 |
| Peptide Mixture 1111 | 3.00 |
| Aspergillus niger | 3.32 |
| Aspergillus oryzae | 2.76 |

### Example 7—Bioactive Peptide Composition Effect on Oral Health

Oral health is not just healthy, clean, teeth; it is also the maintenance of all tissue in the oral cavity to prevent problems in the future. Periodontal disease for example is one of the most common and serious health problems for many humans as well as animals. In domestic animals, particularly cats, approximately 70% show symptoms of periodontal disease by the age of 3. For rescue and feral cats, over 90% have periodontal disease. The key to the management of periodontal disease and oral health maintenance is prevention.

A study was conducted to determine the effect of a novel oral health product formulated with a bioactive peptide mixture, 1111, as described in Example 1, Table 1. Data were evaluated on use of the orally administered product over a period of 2 weeks to determine effect of daily administration in ameliorating or preventing periodontal disease.

Tests were conducted on 8 cats fed 2 times a day with a 25 mg dose of the bioactive peptide 1111 combined in a regular cat food as a “treat”. Control treats were fed to all the cats before beginning the trial to determine any effect on the saliva biomarkers measured in the trial. During the study cat 1CM was used as a blind control for comparison of the observed and measured beneficial effects on the other test cats.

Each cat was evaluated at the start of the treatment. Visual and qualitative examination of gums and the oral cavity health at 0 days is shown in Table 8. A follow up evaluation was performed after 7 days and again in 14 days. Results are shown in Tables 9 and 10.

TABLE 8
oral evaluation at day 0

| | | | Redness | | | | | Gum | |
|---|---|---|---|---|---|---|---|---|---|
| Cat/ | Swelling | | and edema | Ulcerations | | | Amount | surfaces | |
| kitten | of gum | Bad | qualitative | in oral | | White | of | bleed | Loose |
| C/K | tissue | Breath | of gums | cavity | Abscesses | patches | plaque | easy | teeth |
| 1CM | 2 | 3 | 2 | 1 | 1 | 1 | 4 | 1 | 2 |
| 2CM | 4 | 5 | 3 | 2 | 0 | 0 | 4 | 3 | 1 |
| 3CF | 3 | 4 | 3 | 3 | 1 | 1 | 3 | 3 | 4 |
| 4CM | 0 | 1 | 0 | 0 | 0 | 0 | 0 | 0 | 0 |
| 5CF | 4 | 4 | 3 | 3 | 0 | 1 | 5 | 3 | 4 |
| 6CM | 2 | 3 | 2 | 1 | 2 | 3 | 5 | 3 | 3 |
| 7CM | 1 | 3 | 2 | 1 | 0 | 0 | 2 | 1 | 0 |
| 8CF | 5 | 4 | 4 | 4 | 3 | 2 | 5 | 5 | 5 |

M = male; F = Female. Cats were neutered a minimum of 4 years prior to the experiment the only exception is cat 4CM who was neutered 1 year prior. 1CM was a “blind” control.

TABLE 9
Oral Evaluation after 7 days

| | | | Redness | | | | | Gum | |
|---|---|---|---|---|---|---|---|---|---|
| Cat/ | Swelling | | and | Ulcerations | | | Amount | surfaces | |
| kitten | of gum | Bad | edema | in oral | | White | of | bleed | Loose |
| C/K | tissue | Breath | of gums | cavity | Abscesses | patches | plaque | easy | teeth |
| 1CM | 2 | 3 | 2 | 1 | 1 | 1 | 4 | 1 | 2 |
| 2CM | 2 | 3 | 2 | 2 | 0 | 0 | 3 | 2 | 1 |
| 3CF | 2 | 4 | 2 | 3 | 1 | 0 | 3 | 2 | 4 |
| 4CM | 0 | 0 | 0 | 0 | 0 | 0 | 0 | 0 | 0 |
| 5CF | 3 | 3 | 3 | 2 | 0 | 1 | 5 | 3 | 4 |
| 6CM | 2 | 2 | 2 | 1 | 2 | 2 | 4 | 2 | 3 |
| 7CM | 0 | 2 | 1 | 1 | 0 | 0 | 2 | 1 | 0 |
| 8CF | 4 | 3 | 4 | 3 | 3 | 1 | 4 | 5 | 5 |

M = male; F = Female. Cats were neutered a minimum of 4 years prior to the experiment the only exception is cat 4CM who was neutered 1 year prior. 1CM was a “blind” control.

TABLE 10
Oral Evaluation after 14 days

| | | | Redness | | | | | Gum | |
|---|---|---|---|---|---|---|---|---|---|
| Cat/ | Swelling | | and | Ulcerations | | | Amount | surfaces | |
| kitten | of gum | Bad | edema | in oral | | White | of | bleed | Loose |
| C/K | tissue | Breath | of gums | cavity | Abscesses | patches | plaque | easy | teeth |
| 1CM | 2 | 5 | 2.5 | 1 | 1 | 1 | 4.5 | 1.8 | 2 |
| 2CM | 1 | 2.8 | 1.5 | 1 | 0 | 0 | 2.5 | 1 | 1 |
| 3CF | 1 | 2 | 1.5 | 2 | 1 | 0 | 2 | 1.5 | 4 |
| 4CM | 0 | 0 | 0 | 0 | 0 | 0 | 0 | 0 | 0 |
| 5CF | 2.5 | 1 | 2.5 | 1 | 0 | 1 | 4 | 2.5 | 4 |
| 6CM | 1 | 1 | 1 | 1 | 1 | 1 | 3 | 1 | 1 |
| 7CM | 0 | 1 | 0 | 0 | 0 | 0 | 1 | 1 | 0 |
| 8CF | 3 | 2.5 | 2 | 2 | 2 | 1 | 3 | 2 | 5 |

M = male; F = Female. Cats were neutered a minimum of 4 years prior to the experiment the only exception is cat 4CM who was neutered 1 year prior. 1CM was a “blind” control.

No specific diagnostic test was used to identify stomatitis or periodontal disease. The presenting signs indicated in the chart were visually rated on a scale of 1-5 with 5 being the highest visible inflammation or damage. Changes over the two-week period of the test were used to measure how the bioactive peptide 1111 composition affected the development of periodontal disease over time.

Diagnosis of stomatitis is generally based on the clinical appearance of the lesions. Generalized mucosal inflammation extending into the caudal (back) parts of the mouth are characteristic of this disease. gingival/gum inflammation alone, even if severe, does not constitute a diagnosis of stomatitis. The inflammation must extend beyond the gingiva into the general oral mucosa and into the caudal regions of the oral cavity. Biopsy may be recommended if lesions are not consistent with stomatitis, such as unilateral (one-sided) inflammation.

Typical presenting signs for periodontal disease were considered but the results did not allow a definitive diagnosis to be made. However, the data indicate that over the observed time period, some degree of periodontitis had occurred. Inflammation of the tissues around and supporting the tooth; the tooth support structures include the gum tissue (known as “gingiva”); the cementum and periodontal ligament (the cementum and periodontal ligament attach the tooth to the bone); and the alveolar bone (the bone that surrounds the roots of the tooth); periodontitis (inflammation/infection of the tissues around and supporting the tooth) indicates some degree of periodontal attachment tissue loss (that is, some loss of the structures [cementum, periodontal ligament, alveolar bone] that attach the tooth to the bone).

### Example 8—Biomarkers in Saliva after Oral Feeding with Bioactive Peptide 1111

Saliva samples were collected from the 8 test cats in the study reported in Example 7. All the cats in the study were on the same diet and were fasted for 2 hours prior to testing the saliva. Treats containing the control formulation and the test formulation were given 2 hours prior to testing. None of the cats in the study were on non-steroidal anti-inflammatory drugs for pain management.

Excess levels of urea and other nitrogenous waste products (known as “uremia”) and high ammonia, and urea levels in saliva have been used to identify the possibility of stomatitis and periodontal disease. A positive correlation of the amount of urea in saliva and that found in serum urea has been reported.

A Kidney-Chek™ test strip was used to measure urea levels. High urea levels are indicative of both acute and chronic kidney disease and can be used to screen for azotemia. None of the cats in the trial had high levels of urea in saliva samples indicating that none of the cats in the study had kidney disease.

Bartovation™ test strips were used to qualitatively measure nitrate and nitrite levels in the saliva of the test cats. No significantly increased levels were observed during the trial period.

A consequence of the use of the bioactive peptide product was an unexpected benefit for various problems associated with mega colon and chronic and acute constipation. The stools of the cats in the study were monitored and photographed to monitor stool conditions over time during the 2-week use of the product and appeared to be normal.

Another unexpected benefit Observed during the test was a decrease in periocular inflammation or excessive eye tearing in the test cats, indicating that the product may be protective for some areas in the nasopharyngeal area.

What is claimed is:

1. A dietary health composition for enhancing and maintaining mammalian health in the oral cavity, the composition comprising:
a sodium aluminosilicate mineral (zeolite),
a dried bacteria/multi-enzyme mixture, and
a substantially pure peptide blend mixture of β-lactoglobulin, α-lactalbumin, albumin and immunoglobulins (peptide blend 1111) obtained from colostrum whey.

2. The composition of claim 1 wherein the dried bacteria/multienzyme mixture is 30-45 weight % of the supplement; wherein the sodium aluminosilicate mineral is 40-60 weight % of the supplement; and wherein the peptide blend (1111) comprises 5-15 weight % of the supplement.

3. The composition of claim 2 comprising 41.6 weight % zeolite, 9.1 weight % peptide blend 1111 and 43.5 weight % of the bacterial/multi-enzyme mixture.

4. The composition of claim 1 wherein the enzymes in the dried bacterial/multi-enzyme mixture comprise xylanase, amylase and protease.

5. The composition of claim 1 wherein the bacteria in the dried bacteria/multi-enzyme mixture comprise Bacillus amyloliquefaciens or Lactobacillus bacteria.

6. The composition of claim 1 wherein the sodium aluminosilicate mineral is a clinoptilolite zeolite.

7. The composition of claim 1 further comprising 2.2 weight % cranberry extract powder, 1.9 weight % zinc sulfate, 0.91 weight % ascorbic acid, 0.55 weight % yucca extract, 0.18 weight % taurine and 0.05 weight % astaxanthin.

8. An oral supplement for saliva heath and immune support in companion and herd animals, comprising 47.5-48.5 weight % of zeolites, 15-17 weight % of lactobacillus bacteria, 4-6 weight % aspergillus bacteria, 1-2 weight % anise oil, 2-2.4 weight % coconut oil, 0.4-1.0 weight % fenugreek seed extract, 0.9-1.3 weight % yucca extract, 1.5-2.0 weight % zinc sulfate, 0.5-1.5 weight % calcium carbonate, 1.5-2.5 weight % cranberry powder, 0.3-0.5 weight % astaxanthin, 0.3-0.6 weight % ascorbic acid, 0.3-0.5 weight % taurine, 3-5 weight % dried yeast extract and 12-20 weight % bioactive peptide blend 1111;
wherein the lactobacillus bacteria are Lactobacillus acidophilus, Lactobacillus fermentum, Lactobacillus plantarum and Lactobacillus casei;
wherein the aspergillus bacteria are Aspergillus niger and Aspergillus oryzae;
wherein the dried yeast extract is Saccharomyces cerevisiae; and
wherein the active peptide blend 1111 is a mixture of β-lactoglobulin, α-lactalbumin, albumin and immunoglobulins obtained from colostrum whey.

9. The oral supplement of claim 8 provided as a daily supplement in cat or dog feed.

10. The oral supplement of claim 9 wherein the supplement is provided up to 20% in the feed.

11. A composition for protecting and maintaining oral cavity health in mammals, comprising bioactive peptide blend 1111 formulated with food or feedstock suitable for oral consumption, wherein the active peptide blend 1111 is a mixture of β-lactoglobulin, α-lactalbumin, albumin and immunoglobulins obtained from colostrum whey.

12. A method for inhibiting development of periodontal disease in a mammal, comprising daily oral administration of an effective amount of the bioactive peptide blend 1111 composition of claim 11.

13. The method of claim 12 wherein the mammal is human, canine, feline or herd animal.

14. The method of claim 13 wherein the feline is a cat.

15. The method of claim 14 wherein the effective amount of bioactive peptide 1111 supplement is about 25-100 mg.

16. The method of claim 12 wherein periodontal disease is exhibited as periodontitis, gingivitis, stomatitis, generalized oral tissue inflammation or bone loss.
